(19) United States
(12) Patent Application Publication
(10) Pub. No.: US 2008/0042379 A1
(43) Pub. Date: Feb. 21, 2008

(54) Collapsible Stroller Backpack

(76) Inventor: Fadi Salim Amran, Fountain, CA (US)

Correspondence Address: Rutan & Tucker, LLP.;Hani Z. Sayed, 611 ANTON BLVD, SUITE 1400, COSTA MESA, CA, 92626, US

(21) Appl. No.: 10/542,222

(22) PCT Filed: Dec. 16, 2003
(86) PCT No.: PCT/US03/40163

§ 371 Date: May 1, 2007

(51) Int. Cl. B62B 3/02

(52) U.S. Cl. 280/30

(57) ABSTRACT

A collapsible stroller backpack (“CSB”) (100) where the CSB alternately functions as a backpack with an included collapsible stroller, and as a stroller having a container (110). Items in the container need not be removed as the CSB changes from a backpack configuration to a stroller configuration. In the preferred embodiment, when in the backpack configuration the CSB is not designed to be used to carry a child.

### FIELD Of THE INVENTION

The field of the invention is strollers.

### BACKGROUND OF THE INVENTION

In situations where one is performing an activity with a child where the activity requires walking, it is sometimes preferable to allow the child to ride in a stroller, possibly because the child has become tired of walling. In some such situations it may be inconvenient or impossible to place a stroller in storage and to retrieve it as it is needed with the result that a stroller may be taken along and kept close at hand during the activity. Unfortunately an empty stroller ends up being pushed around at times when the child is walking. Moreover, if traversing steps or crowded spaces, keeping a stroller close at hand can be difficult.

In such a situation one might use a collapsible stroller such that the stroller is carried in collapsed form when not in use. As an example, the U.S. Pat. No. 6,220,621 describes a foldable stroller that is provided with a carrying case. Similarly, U.S. Pat. No. 5,899,467 describes a hand carried suitcase that converts into a stroller. Unfortunately, having to carry something in one's hands while simultaneously trying to keep control of small children isn't always convenient and can be problematic.

For infants, the use of a “stroller backpack” that is essentially an infant backpack (i.e. a backpack adapted for carrying infants) that can be converted to a stroller is an option. Examples are described at least in the U.S. Pat. Nos. 5,964,470, 5,230,523, 4,915,401, 4,762,256, 4,487,428, 5,820,140, 5,779,248, 6,155,579, and 4,586,721, and in PCT publication number WO9962753, and shown in U.S. design patents numbered Des. 357438 and Des. 365925. Unfortunately, the use of a stroller backpack as taught in the prior art tends to eliminate the ability to carry other items in a backpack/knapsack. At the very least, space taken up by an infant being carried isn't available for carrying items, and the space in which an infant is carried often has a number of openings through which items can fall.

It should also be noted that various forms of “portable backpacks” (i.e. backpacks provided with wheels such that they can be pushed or pulled along without being carried) are known. Examples of such can be found at least in the U.S. Pat. Nos. 5,743,447, 4,368,835, 5,893,495, 6,550,651, 6,651,395, 5,515,954, 5,984,154, and 6,179,176, and the U.S. patent applications numbered 2002/0096410 and 2002/0145018.

Also known are various types of portable chairs (that aren't strollers because they aren't adapted to be pushed or pulled when being sat upon). Examples include those described in the U.S. Pat. Nos. 3,266,686 and 5,209,381 which are in “backpack” form, and D459883 which is intended to be held in one's hand.

### SUMMARY OF THE INVENTION

The present invention is directed to a collapsible stroller backpack (“CSB”) where the CSB alternately functions as a backpack with an included, collapsed stroller, and as a stroller having a container. Items in the container need not be removed as the apparatus moves from the backpack configuration to the stroller configuration. In a preferred embodiment, when in the backpack configuration the apparatus is not designed to be used to carry a child.

The CSB disclosed herein allows someone to (a) bring a stroller along on an outing without having to push the stroller or carry it in hand when it is not being used to move a child, (b) to carry items that are not part of the CSB regardless of whether it is configured as a stroller or as a backpack, and (c) to carry items without having to unload or shift them to a different portion of the CSB while the CSB configuration is being changed.

A “stroller” as the term is used herein is a light chair like carriage with three or more wheels for transporting small children.” A “backpack” as the term is used herein is an apparatus comprising a bag or other container that is designed to allow someone to carry articles, not people, within the bag and on their back, possibly by providing it with should straps. A backpack will often be made of a sturdy material and may be mounted on a lightweight frame.

As used herein, the term “collapsed” indicates a configuration wherein an apparatus can be enclosed in a smaller volume than when not in a collapsed configuration, but is not limited to any particular manner of collapsing the apparatus. As such, collapsing a device may include folding, bending, rotating, sliding, crumpling, and/or performing some other action on one or more components or on the apparatus as a whole. Collapsing, as used herein, does not include disassembly of the entire apparatus but may include disassembly of portions of the apparatus if such portions are adapted to be readily disassembled and reassembled. A “collapsible” apparatus, as used herein, is an apparatus having both a collapsed and un-collapsed configurations.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1A is a perspective view of a collapsible stroller backpack embodying the invention.

FIG. 1B is a side view of the stroller backpack of FIG. 1 configured as a stroller.

FIG. 1C is a front view of the stroller backpack of FIG. 1 configured as a backpack.

FIG. 1D is a back view of the stroller backpack of FIG. 1 configured as a backpack.

FIG. 2 is a perspective view of a stroller backpack being worn while configured as a backpack.

### DETAILED DESCRIPTION

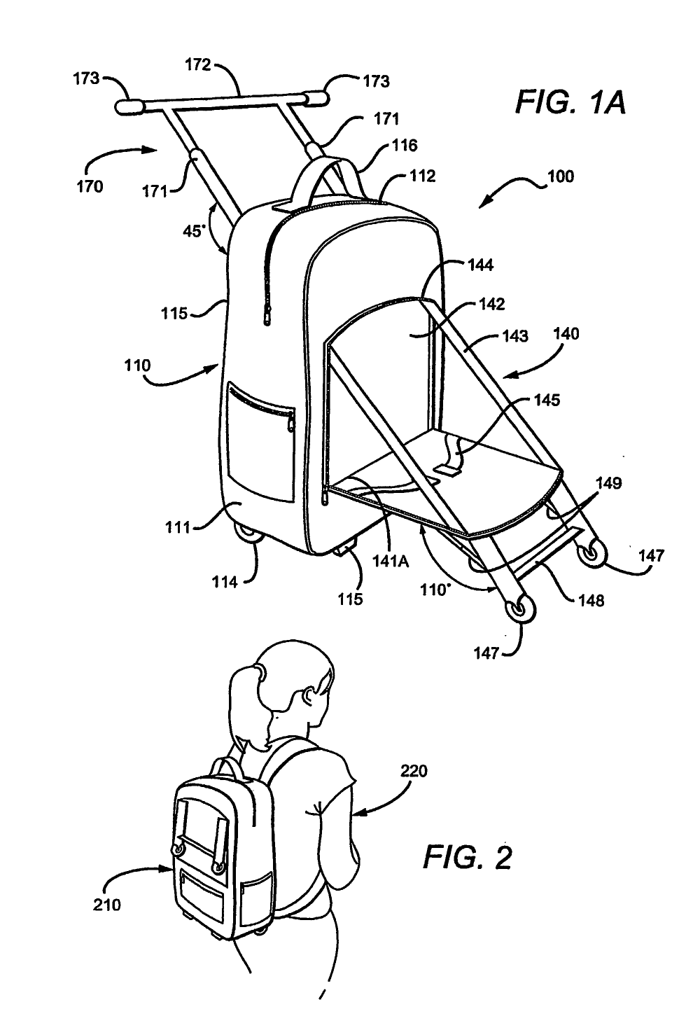

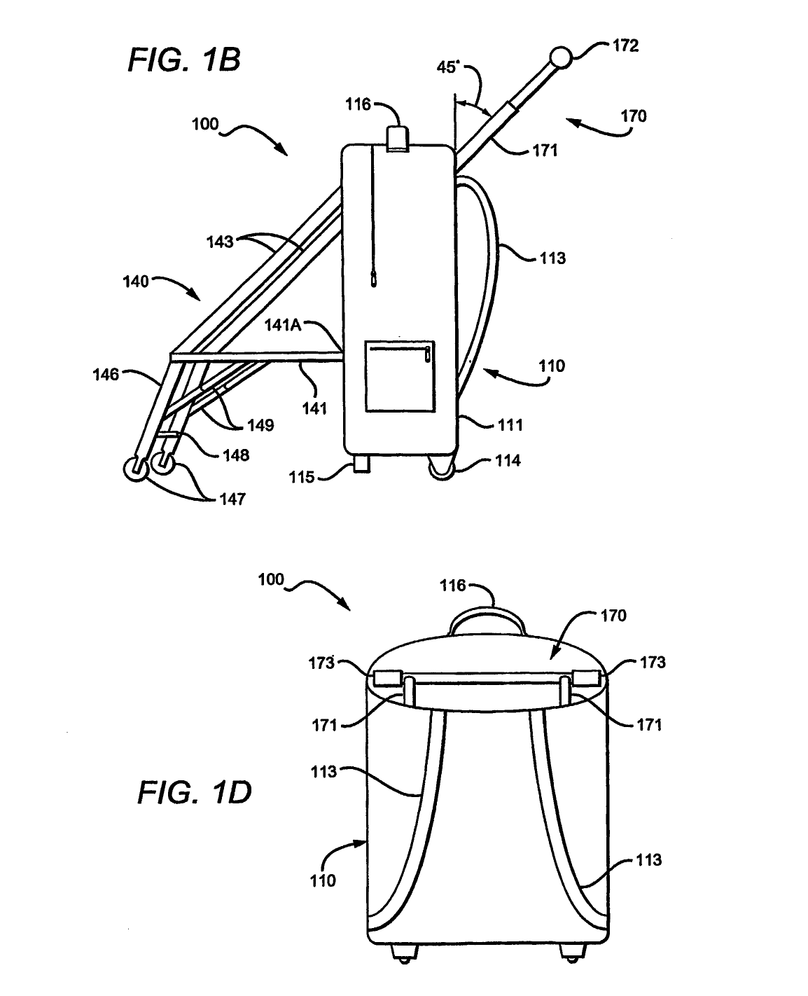

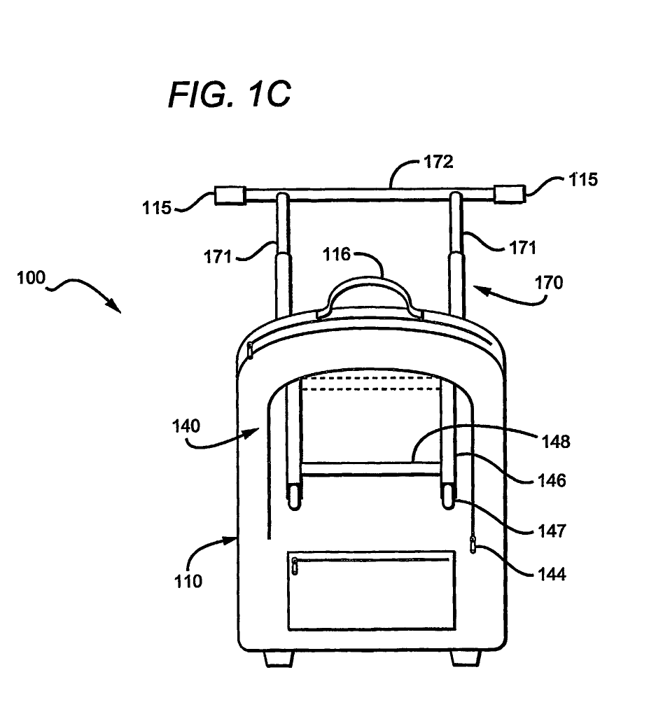

Referring to FIGS. 1-5, a collapsible stroller backpack (“CSB”) 100 comprises a combination of a collapsible stroller and a backpack. CSB 100 comprises container assembly 110, seat assembly 140, and handle assembly 170. Container assembly 110 comprises a body 111 having an internal cavity accessible via a zippered opening 112, shoulder straps 113, wheels 114, feet 115, a handle 116 and a back contacting portion 117. Seat assembly 140 comprises a fold down seat platform 141, a back rest portion 142, restraining straps 143, zipper retaining fastener 144, seat belt 145, wheel support 146, wheels 147, foot rest 148, and locking hinges 149. Handle assembly 170 comprises extendable arms 171 and handle 172 with extendable grips 173. Handle assembly 170 is adapted to be adjustable from a first position wherein it is substantially parallel with the back contacting portion 117 of the container assembly 110 to a second position where it projects outward at an angle from body 111. Fold down seat platform 141 is coupled to container assembly 110 at joint 141A, and is adapted to be folded and zippered in place parallel to back rest portion 142 and to a portion of body 111. It should be noted that the term “parallel” is being used loosely to describe minimizing the angle between seat platform 141 and back rest portion 142 in an attempt to have seat platform 141 pressed flat against back rest portion 142.

Preferred CSBs such as CSB 100 are configurable in at least two, and possibly in three or more different configurations. In a first configuration the CSB 100 is suitable for use as a stroller for moving a child while in a second it is suitable for use solely as a backpack. A third configuration allows the backpack to be towed and/or pushed in a manner similar to other wheeled backpacks while the seat assembly remains collapsed.

Shifting CSB 100 from its backpack configuration to its stroller configuration involves extending handle assembly 170 and unfolding seat platform 141. Extending handle assembly 170 comprises extending it upwards so that it projects away from the container assembly 110, adjusting the handle assembly so that it is angled approximately thirty to forty five degrees (30°-45°) from the plane defined by back contacting portion 117, and by extending grips 173 from handle 172. Unfolding seat platform 141 comprises unzipping seat platform 141 by unzipping fastener 144 and allowing seat platform 141 to fold out so that it projects outward from container assembly 110 and back rest portion 142, and positioning wheel support 146 so that it projects downward at an angle from seat platform 141, preferably at about a one hundred and ten degree (110°) angle relative to seat platform 141. Locking hinges 149 facilitate setting an maintaining the position of wheel support 146. In alternative embodiments, the relative angles between the handle and body, between the seat platform and body, and between the seat platform and wheel supports may differ, or may be adjustable.

CSB 100 preferably comprises, as part of or in addition to the assemblies described herein, one or more aluminum frames that provide rigidity and/or support to such assemblies. However, alternative embodiments may utilize different types of frames such as graphite or composites frames. In alternative embodiments any type of supporting frame that does not prevent CSB 100 from being used alternately as a backpack and as a stroller may be used.

Container assembly 110 is, other than being combined with a collapsible stroller, a standard backpack and thus may comprise any features of other backpacks that do not prevent CSB 100 from being used alternately as a backpack and as a stroller. As such, in addition to other features, container assembly 110 may comprise various pockets, pouches, straps, fasteners and supporting frames.

Body 111 defines an internal cavity accessible via a zippered opening. Although body 111 may be formed from any material or combination of materials suitable for use in a backpack body that does/do not prevent CSB 100 from being used alternately as a backpack and as a stroller, it is currently preferred that body 111 comprise one or more pieces of water resistant cloth seamed together and otherwise adapted to form the shape of body 111.

The internal cavity of body 111 is accessible via zippered opening 112. However, other embodiments may utilize alternative or additional access methods that do not prevent CSB 100 from being used alternately as a backpack and as a stroller. Such methods may include but are not limited to the use of buckled flaps, drawstrings, and flaps fastened with hook-and-loop (Velcro®) fasteners.

Although the internal cavity of body 111 may be shaped and dimensioned in any manner that does not prevent CSB 100 from being used alternately as a backpack and as a stroller, CSB 100 is intended to provide maximum functionality as a backpack and the cavity should be shaped and sized appropriately. In a particular embodiment body 111 may comprise a plurality of cavities, possibly in the form of additional pockets. However, preferred embodiments will comprise at least one cavity that is at least nine inches (9″) across, twelve inches (12″) high, and four inches (4″) deep such that it has a volume of at least four hundred and thirty two cubic inches (432 in³).

Although shown with shoulder straps 113, container assembly 110 may comprise one or more additional or alternative carrying mechanisms, handle 116 being an example of such, so long as such mechanisms do not prevent CSB 100 from being used alternately as a backpack and as a stroller.

Wheels 114 are preferably 3 inch diameter wheels positioned adjacent to the corners of back contacting portion 117, and are preferably positioned such that they will not normally come in contact with someone carrying CSB 100 while it is being carried. Wheels 114 are preferably fixed but may be able to swivel three hundred and sixty degrees (360°), or may be moveable in some other fashion. Although shown with wheels, alternative embodiments may utilize other types or configurations of wheels, or other mechanisms such as but not limited to tracks, sliders and ground effect mechanism so long as the mechanism chosen does not prevent CSB 100 from being used alternately as a backpack and as a stroller.

Feet 115 are preferably formed of a plastic or composite material, extend outward from the bottom of container assembly 110 so as to allow CSB 100 to stand upright while contacting the ground or other supporting surface via wheels 114 and feet 115. However, alternative embodiments may utilize other mechanisms such as additional wheels to provide similar or additional functionality to CSB 100 so long as any mechanism chosen does not prevent CSB 100 from being used alternately as a backpack and as a stroller.

Back contacting portion 117 in the preferred embodiment is simply and exterior surface of body 111. However, alternative embodiments may employ pads, harnesses or other mechanisms so long as any mechanism chosen does not prevent CSB 100 from being used alternately as a backpack and as a stroller.

At various times within this disclosure, back contacting portion 117 is referred to as defining a plane. For embodiments where back contacting portion 117 is not itself substantially planar, the plane defined is any plane that would contact at least one point of back contacting portion 117 and at least two points on the skin of a person wearing CSB 100 where the points are on protrusions from each of the person's shoulder blades. Where back contacting portion 117 is substantially but not truly planar, the plane defined is any plane contacting or passing through at least three points of back contacting portion 117.

Seat assembly 140 may, in addition to or in place of any mechanism described herein, comprise any mechanism that permits a child to be supported by CSB 100 while it is configured as a stroller and being pushed or pulled so long as any mechanism chosen does not prevent CSB 100 from being used alternately as a fully functional backpack (i.e. as a container for carrying items and not people) and as a stroller.

Fold down seat platform 141 preferably comprises a framed rectangular sheet of material sized to provide a comfortable seat for a child. When unfolded, seat platform 141 is preferably positioned parallel to the ground at a distance approximately eight inches (8″) from the ground. However, alternative embodiments may utilize any mechanism suitable for supporting a child so long as any mechanism chosen does not prevent CSB 100 from being used alternately as a backpack and as a stroller. Similarly, although platform 141 folds down by pivoting relative to a hinge portion in the preferred embodiment, alternative embodiments may operate in a different fashion. In addition, the position of seat platform 141 relative to the ground may vary between embodiments.

Back rest portion 142 is preferably just a piece of cloth or a pad coupled to a portion of body 111 of container assembly 111. However alternative embodiments may utilize some other mechanism is providing back support to a child riding in CSB 100 when it is configured as a stroller, or may not provide any back support at all.

Restraining straps 143 prevent seat platform 141 from rotating more than ninety degrees (90°) relative to back rest portion 143 and preferably forms a sixty degree (60°) angle relative to seat platform 141 and a thirty degree (30°) angle relative to back rest portion 143. Alternative embodiments may utilize any configuration of straps, brackets or other mechanisms in place of or in addition to straps 143 that is/are necessary to position seat platform 141 to be sat on by a child so long as any mechanism chosen does not prevent CSB 100 from being used alternately as a backpack and as a stroller.

Zipper retaining fastener 144 is intended to retain seat platform assembly 141 is a folded position when CSB 100 is configured as a backpack. However, alternative embodiments may utilize alternative fastening mechanisms to achieve the same or similar purpose, or a different purpose an alternative support structure and/or coupling method is used.

The preferred embodiment includes a mechanism for restraining a child while it is riding in CSB 100 while CSB 100 is configured as a stroller. In the preferred embodiment the restraining mechanism takes the form of seat belt 145 coupled to the frame of CSB 100 and positioned near the rear of seat platform 141. Alternative embodiments may utilize a harness or some other mechanism is addition to or in place of seat belt 145.

In the preferred embodiment wheel support 146 couples wheels 147 to seat platform 141 such they extend downward from seat platform 141 at a relative angle of one hundred and ten degrees (110°) with the relative position being set and maintained by hinges 149. However, alternative embodiments may utilize some other mechanism for coupling wheels 147 to seat platform 141 or directly to container assembly 110, or may utilize some other mechanism for providing adequate stability to back pack 100 when it is configured as a stroller. In some embodiments wheel support 146 may comprise a foot rest 148. Wheels 147 are preferably three inches (3″) in diameter and able to swivel three hundred and sixty degrees (360°). Foot rest 148 is preferably formed by extending a piece of cloth across a portion of wheel support 146.

Handle assembly 170 is adapted to be adjustable from a first position wherein it is substantially parallel with the back contacting portion 117 of the container assembly 110 to a second position where it projects outward at an angle from body 111 relative to a plane defined by the back contacting portion. It is also preferred that handle 170 be removable or collapsible, at least when in the first position, such that it any interference it causes with carrying the backpack will be minimized.

It should be noted that the ability to tilt handle assembly 170 relative to container assembly 110 is applicable to backpacks other than CSBs. It is contemplated that providing a backpack equipped with wheels with a tilting handle similar to that described herein will permit one to pull a backpack without having to tip the backpack as far and having to consequently exert more effort in preventing the backpack from tipping over, and may also help prevent the backpack from interfering with walking as it is pulled along.

Extendable arms 171 preferably each comprise two or more concentric cylinders such that a segment of the handle can slide into another segment of the handle. Alternative embodiments may utilize alternative mechanisms in place of arms 171 so long as any mechanism chosen does not prevent CSB 100 from being used alternately as a backpack and as a stroller. Handle 172 is preferably a rigid member extending between arms 171 and coupled to grips 173 such that grips 173 can either be removed from or moved relative to arms 171 to allow any interference grips 173 may cause with carrying backpack 10. Grips 173 and/or handle 172 are preferably adapted to promote comfortable pushing or pulling of CSB 100, possibly by incorporation of a padded surface.

FIG. 2 illustrates a CSB 210 with the seat and handle assemblies collapsed to facilitate being carried by a person 220. As shown in the figure, when collapsed, the handle assembly does not project above the top of body 111. This is a characteristic of the preferred embodiment which may not be true for all embodiments.

It is important to note that CSB 100 embodies numerous novel features that, individually and in combination, distinguish it from prior art strollers and backpacks. As such, it may be characterized in a number of ways using one or more of such features. The following paragraphs provide some exemplary characterizations, but the list is not-exhaustive as other combinations are contemplated and would be readily apparent to one of average skill in the art after reading this disclosure.

A first characterization is that it is a CSB configurable in at least two configurations wherein a first configuration is a stroller configuration wherein the backpack comprises a seat assembly adapted to receive a child, and a second configuration is a backpack configuration wherein the CSB is adapted to be worn and to carry items, but the seat assembly is no longer adapted to receive a child. Such a characterization may be supplemented by stating that it includes at least one container wherein the seat assembly comprises a seat that projects farther from the at least one container while the CSB is configured as a stroller than it does when the CSB is configured as a backpack. The phrase “adapted to receive a child” indicates that the backpack includes a seat assembly or similar mechanism that is sized and dimensioned for a child to sit on, and comprises a supporting structure and is coupled to the rest of the backpack in a manner, preferably as described herein, for that purpose. The phrase “adapted to be worn and to carry items” indicates that it comprises shoulder straps or a similar carrying mechanism and includes a cavity sized and dimensioned to receive items. The phrase “no longer adapted to receive a child” indicates that the backpack, when configured as such, is no longer suitable for carrying a childe and, as such, cannot readily be used to carry a child when being used as a backpack. The fact that it cannot readily be used in such a fashion is a major difference between the CSBs described herein and prior art apparatus that are sometimes referred to as “stroller backpacks”. The characterization may be supplemented by reference to additional features described herein such as a seat that is folded up and zippered to the body of the CSB when it is configured as a backpack, a rotateable handle, positioning of the wheeled seat relative to the shoulder straps, and moveable grips.

A second characterization is that it is a CSB comprising at least one pair of shoulder straps coupled to a first side of a container, and a wheeled seat portion extending outward from a different side of the container.

A third characterization is that it is a CSB alternately configurable as a stroller and a backpack and comprising a handle rotateably coupled to the frame wherein the handle is adapted for use in pushing, pulling, or directing the CSB when it is configured as a stroller. As discussed, having the handle rotateably coupled to the frame allows the position of the handle relative to the body of the backpack to be adjusted when transitioning between the backpack configuration and the stroller configuration.

A fourth characterization is that it is a CSB comprising a handle having a fixed portion and at least two grip members moveably coupled to the handle such that they can either be detached from the handle or can be repositioned relative to another member of the handle. This characterization may be supplemented by stating that the extensions are slideably connected to opposite ends of a crossbar and are adapted to slide into and out of the ends of the crossbar.

As the foregoing text and the figures makes apparent, a method of changing the configuration of a CSB such as CSB 100 comprising a handle assembly, a container assembly and a seat assembly, the method comprising extending the handle assembly so that it projects outward from the container assembly and causing the seat assembly to project outward from the container assembly and away from the handle assembly. Doing so may involve one or more of the following steps, either individually or in combination: rotating a portion of the handle assembly relative to the container assembly to change the relative angle between that portion of the handle assembly and the container assembly; extending a pair of grips outward from a portion of the handle assembly, and/or causing the seat assembly to project outward from the container assembly comprises unzipping and unfolding the seat assembly; and/or subsequently collapsing the handle assembly and the seat assembly such that they are in the same position relative to the container assembly as they were prior to being extended and caused to project outward.

It should be noted that the term “mechanism” as used herein as a generic term to refer to an object, combination of objects, method, and/or set of methods. As such, its use includes at least any type of apparatus, assembly, material, set of materials, structure, method or technique, and should not be narrowly interpreted.

Thus, specific embodiments and applications of collapsible stroller backpacks have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A collapsible stroller backpack configurable in at least three configurations wherein:
a first configuration is a stroller configuration wherein the stroller backpack comprises a seat assembly adapted to receive a child; and
a second configuration is a backpack configuration wherein the stroller backpack is adapted to be worn and to carry items while the seat assembly is not adapted to receive a child;
a third configuration is a portable backpack configuration wherein the stroller backpack is adapted to be pushed or pulled along the ground using a handle extended from the stroller backpack while the seat assembly is not adapted to receive a child.

2. A collapsible stroller backpack configurable in at least two configurations wherein:
a first configuration is a stroller configuration wherein the backpack comprises a seat assembly adapted to receive a child; and
a second configuration is a backpack configuration wherein the stroller backpack is adapted to be worn and to carry items, but the seat assembly is no longer adapted to receive a child.

3. The stroller backpack of claim 2 further comprising at least one container wherein the seat assembly comprises a seat that projects farther from the at least one container while the stroller backpack is configured as a stroller than it does when the stroller backpack is configured as a backpack.

4. The stroller back pack of claim 2 wherein the stroller backpack is alternately configurable as a stroller and a backpack and comprises a handle rotateably coupled to the frame wherein the handle is adapted for use in pushing, pulling, or directing the stroller backpack when it is configured as a stroller.

5. The stroller back pack of claim 2 stroller backpack comprising at least one pair of shoulder straps coupled to a first side of a container, and a wheeled seat portion extending outward from a different side of the container.

6. The stroller backpack of claim 2 comprising a handle having a fixed portion and at least two grip members moveably coupled to the handle such that they can either be detached from the handle or can be repositioned relative to another member of the handle.

7. The backpack of claim 6 wherein the extensions are slideably connected to opposite ends of a crossbar and are adapted to slide into and out of the ends of the crossbar.

8. A stroller backpack alternately configurable as a stroller and a backpack and comprising a handle rotateably coupled to the frame wherein the handle is adapted for use in pushing, pulling, or directing the stroller backpack when it is configured as a stroller.

9. The stroller backpack of claim 8 wherein the handle has a fixed portion and at least two grip members moveably coupled to the handle such that the at least two grip members can either be detached from the handle or can be repositioned relative to another member of the handle.

10. The backpack of claim 9 wherein the extensions are slideably connected to opposite ends of a crossbar and are adapted to slide into and out of the ends of the crossbar.

11. The backpack of claim 10 comprising at least one pair of shoulder straps coupled to a first side of a container, and a wheeled seat portion extending outward from a different side of the container.

12. The backpack of claim 11 wherein the backpack is configurable in at least a first configuration that is a stroller configuration wherein the backpack comprises a seat assembly adapted to receive a child, and a second configuration that is a backpack configuration wherein the stroller backpack is adapted to be worn and to carry items, but the seat assembly is no longer adapted to receive a child.

13. The backpack of claim 12 wherein the backpack comprises wheels and is also configurable as a portable backpack such that it can be pushed or pulled on the wheels while not configured as a stroller.

14. A stroller backpack comprising a handle having a fixed portion and at least two grip members moveably coupled to the handle such that they can either be detached from the handle or can be repositioned relative to another member of the handle.

15. The backpack of claim 14 wherein the extensions are slideably connected to opposite ends of a crossbar and are adapted to slide into and out of the ends of the crossbar.

16. A collapsible stroller backpack comprising a collapsible seat assembly and an extendable handle and container wherein the handle and seat assembly are coupled to the body, and the handle can be extended while the seat assembly remains collapsed.

17. A method of changing the configuration of a stroller backpack comprising a handle assembly, a container assembly and a seat assembly, the method comprising extending the handle assembly so that it projects outward from the container assembly and causing the seat assembly to project outward from the container assembly and away from the handle assembly.

18. The method of claim 17 further comprising rotating a portion of the handle assembly relative to the container assembly to change the relative angle between that portion of the handle assembly and the container assembly.

19. The method of claim 18 further comprising extending a pair of grips outward from a portion of the handle assembly.

20. The method of claim 19 wherein causing the seat assembly to project outward from the container assembly comprises unzipping and unfolding the seat assembly.

21. The method of claim 17 further comprising subsequently collapsing the handle assembly and the seat assembly such that they are in the same position relative to the container assembly as they were prior to being extended and caused to project outward.
